(19) United States
(12) Patent Application Publication
(10) Pub. No.: US 2014/0106223 A1
(43) Pub. Date: Apr. 17, 2014

(54) METHODS FOR SURFACE COATING OF CATHODE MATERIAL LiNi0.5-XMn1.5MXO4 FOR LITHIUM-ION BATTERIES

(71) Applicant: Hefei Guoxuan High-Tech Power Energy Co., Ltd., Hefei (CN)

(72) Inventors: Peng Xu, Anhui (CN); Benhao Zhao, (US); Chen Yang, (US); Xulai Yang, (US); Dajun Liu, (US); Jia Xie, Lake Jackson, TX (US); Zhen Li, Hefei (CN)

(73) Assignee: HEFEI GUOXUAN HIGH-TECH POWER ENERGY CO., LTD., Hefei (CN)

(21) Appl. No.: 13/912,072

(22) Filed: Jun. 6, 2013

(30) Foreign Application Priority Data
Oct. 12, 2012 (CN) 201210385431.5

(51) Int. Cl. H01M 4/36; H01M 4/04

(52) U.S. Cl. CPC H01M 4/366; H01M 4/0471
USPC 429/220; 429/223; 429/221; 427/58

(57) ABSTRACT

A high-voltage lithium-ion battery cathode material includes LiNi_{0.5-x}Mn_{1.5}MₓO₄ (0≦x≦0.2, M═Mg, Zn, Co. Cu, Fe, Ti, Zr, Ru, and Cr), which is coated with a coating material, which may be a carbon coating material, a metal phosphate coating material, or a combination thereof. The carbon coating material may be acetylene black, graphene oxide, conductive graphite, glucose, sucrose, starch, lactose, maltose, phenolic resins, polyvinyl alcohol, or a combination thereof, and the metal phosphate coating material may be FePO₄, LiFePO₄, CoPO₄, Mn₃(PO₄)₂, LnPO₄. The coating material may account for 1 to 10% (wt %). Products of the present invention have high reversible capacities. Synthesis methods are disclosed that are simple and controllable, can produce uniform coating, and are suitable for industrial scale production.

### CROSS REFERENCE TO RELATED APPLICATIONS

The claims the priority of Chinese patent application No. 201210385431.5, filed on Oct. 12, 2012, the disclosure of which is incorporated by reference in its entirety.

### TECHNICAL FIELDS

The invention relates to cathode materials for high-voltage lithium ion batteries, particularly relates to lithium battery cathode materials with surface coatings.

### TECHNICAL BACKGROUND

With the rapid development of various portable electronic devices, communication equipment, power tools, and electric vehicles, batteries have become the focus of national research interests as important components of electrical energy storage forms. Lithium ion batteries are the latest generation of secondary batteries, following the nickel-cadmium and nickel metal hydride batteries. As compared with the traditional secondary batteries, lithium-ion batteries have apparent advantages of: (1) higher operation voltages: the commodity lithium-ion battery operation voltage is 3.6V, which is three times that of nickel-cadmium and nickel metal hydride batteries; (2) higher specific energy: specific energy of lithium-ion battery has reached 180 Wh/kg, which is three times that of nickel-cadmium and 1.5 times that of nickel metal hydride batteries; (3) Long cycle life: lithium ion batteries typically have life times of more than 1000 cycles, far more than the previous generation of secondary batteries; and (4) fast charge/discharge, and no memory effects. In addition, lithium-ion batteries are not hazardous, present no environmental pollution, and are in line with sustainable development and environmental friendliness requirements.

While all materials in a battery affects the specific energy of the battery, the cathode material by far has the most impact on high capacity and superior power delivery of the lithium ion batteries. Therefore, properties of lithium ion batteries are often determined by the cathode materials. Common cathode materials for commercial lithium-ion batteries include layered LiCoO₂, olivine LiFePO₄, and spinel LiMn₂O₄. Layered lithium cobalt oxide (LiCoO₂) materials are scarce, expensive, not environmentally friendly, and unsafe. They are not suitable as a common type of battery materials, even if these materials are used only as base materials to develop binary or ternary materials. Therefore, such materials (LiCoO₂) can only be used in small portable devices.

Olivine lithium iron phosphates have the advantages of low prices, environmentally friendly, and good performance. However, they also have the shortcomings of low tap density, low energy density, etc., which limit their applications as power batteries.

The biggest problem with spinel lithium manganese oxide is the poor cycle performance, especially under high temperature conditions. The trivalent manganese ions in the materials, as well as the divalent manganese ions formed at particle surfaces during high-rate discharges, significantly increase the solubilities of these materials in the electrolytes, ultimately undermining their structural integrities. Commercially available lithium manganese oxides are prepared by modification of these properties. The modification undoubtedly increases the manufacturing costs of these materials and also reduces the reversible capacities of these materials.

The spinel LiNi_{0.5-x}Mn_{1.5}MₓO₄ (0≦x≦0.2, M═Mg, Zn, Co, Cu, Fe, Ti, Zr, Ru, and Cr) has a structure similar to that of lithium manganate (i.e., lithium manganese oxide) and has a three-dimensional structure with large tunnels. This structure is suitable for the diffusion of lithium ions, has a very good thermodynamic stability, and has good safety. Compared with lithium manganate oxide, addition of nickel ion on one hand eliminates the formation of trivalent manganese ion, reducing the Jahn-Teller effect (geometrical distortion of molecules and ions associated with certain electron configurations), and on the other hand elevates the voltage platform of the material to 4.7V, improving the energy densities of the batteries. These properties give lithium nickel manganese oxide the most potential in the applications as lithium ion battery cathode materials in all electric vehicles, gaining wide attention in the world.

However, for lithium battery cathode materials in the existing electrolyte systems, in particular the high-voltage spinel LiNi_{0.5-x}Mn_{1.5}MₓO₄ materials, a common problem is: with an increased number of charge-discharge cycles, the electrode charge-discharge capacities and cycle-reversible capacities gradually decrease, resulting in short battery lives. Studies have shown that, in the charging-discharging processes, the electrolytes are oxidized and degraded in 5V high voltage environment, producing carbon nanostructures deposited onto the material surface to form a carbide film, which hinders the deintercalation of lithium ions. With increased cycles, available lithium ions gradually diminish and the reversible capacity is seriously degraded. At the same time, the low conductivity of the spinel lithium nickel manganese oxide affects the electron conductivity in the materials, reducing the electrical properties of the power batteries. To solve the above problems, the researchers performed surface modification of these materials, such as coating metal oxides on the surfaces of cathode active materials, in order to reduce the adverse effects at the interfaces of the active materials and electrolytes, thereby improving their cycle stabilities.

Zhang et al. (J. Alloys Compd, 2011, 509, 3783-3786) disclose a method that comprises dissolving a resin in a solvent and then adding an active material and carbon black to the solution. The mixture is ultrasonically dispersed at 50° C. for 2 h, filtered, dried at 300° C. for 3 h, to afford an active material-carbon composite. XRD analysis showed that addition of a small amount of carbon black not only did not destroy the crystal structure of the active material, but also coated some active material particles to join them into aggregates. In addition, addition of carbon black increases the conductivity of the material from 7.23×10⁻⁷ Scm⁻¹ to 4.11×10⁻⁶ Scm⁻¹. The electrical property tests show that with 0.2 C charge and 1 C discharge cycle for 100 times, the carbon composite material maintains better capacity by 10%, as compared with pure cathode materials. Therefore, addition of carbon improves the rate and cycling performance of the materials. However, this method does not produce true coatings and cannot fundamentally improve the electrical properties of the materials.

Wu et al. (J. Power Source 2010, 195, 2909-2913) discloses a sol-gel method, which coats the LiNi_{0.5}Mn_{1.5}O₄ surface with ZrP₂O₇ and ZrO₂. The tap density of this material reaches up to 2 g/cm³. Therefore, it can have a high energy density. At room temperature, the active material with or without coating perform similarly after 50 cycles of charge and discharge. However, at 55° C., after 150 charge-discharge cycles, the pure active material lost 27% of its capacity, whereas the coated active material lost only 20% of its capacity.

Liu et al. (J. Electrochem. Chem. 2009, 156, A66-A73) discloses coating the surface of active material LiNi_{0.42}Mn_{1.5}Zn_{0.08}O₄ using a precursor of a coating material in a precipitation method. After high temperature calcination, active materials coated with Al₂O₃, Bi₂O₃, or ZnO were obtained, wherein the coating material accounts for 2 percent of the total mass. The electrical property tests show that after three cycles, the 5 C rate discharge capacity is 115 mAh/g or more. The active material coated with Al₂O₃ has a discharge capacity over 128 mAh/g, after 50 cycles of discharges at 0.2 C rate. As compared to the pure cathode active materials, the performances of these coated materials are greatly increased.

Chinese Patent Application No. CN101212046A discloses a method for coating cathode materials for lithium ion secondary batteries. The process includes heating a mixture containing a cathode active material and a solution containing a coating agent. The mixture is first heated at 40-100° C. under stirring until the coating agent precipitates on the surface of the cathode active material. The second step involves heating the positive active material with the coating agent in an inert atmosphere at 200-600° C. for 2-20 h, to produce an evenly coated carbon layer. After 500 charge-discharge cycles, the capacity of this material remains at 93.02%, but its first discharge capacity is relatively low.

Chinese Patent Application No. CN102005563A discloses a method for coating LiNi_{0.5}Mn_{1.5}O₄ active material with lithium-doped Al₂O₃. The resulting material has an initial discharge capacity of 137 mAh/g. However, the cycle performance of this material is relatively poor, after 50 cycles of 0.2 C charge-discharge, this material retains only 88.5% of its initial capacity.

### SUMMARY OF THE INVENTION

An object of this invention is to provide methods for coating cathode materials of high-voltage lithium ion batteries. Using surface coating techniques, the spinel LiNi0.5 cathode material LiNi_{0.5-x}Mn_{1.5}MₓO₄ (0≦x≦0.2, M═Mg, Zn, Co, Cu, Fe, Ti, Zr, Ru, or Cr) may be coated with carbon materials and metal phosphates to produce high-voltage lithium ion battery cathode materials with high discharge rates and high cycle stabilities. The synthesis methods are simple with low energy consumption. In addition, the techniques are simple and controllable; they can be easily adapted for industrial scale productions.

Embodiments of the present invention provide the following technical solutions: coated cathode materials for high-voltage lithium-ion batteries, wherein the lithium-ion battery cathode materials are based on LiNi_{0.5-x}Mn_{1.5}MₓO₄, the surfaces of which are coated with 1-10% (weight % based on the mass of the substrates) of functional materials. The functional materials may be carbon materials and metal phosphates.

One aspect of the invention relates to cathode materials. A cathode material in accordance with one embodiment of the invention includes substrate particles comprising a substance having the formula: LiNi_{0.5-x}Mn_{1.5}MₓO₄, wherein 0≦x≦0.2, and M is Mg, Zn, Co, Cu, Fe, Ti, Zr, Ru, or Cr; and a coating material coated on surfaces of the substrate particles, wherein the coating material comprises a carbon material, a metal phosphate material, or a combination thereof.

In accordance with some embodiments of the invention, any one of the cathode materials described above may comprise a coating material selected from carbon materials. In accordance with some embodiments of the invention, any one of the cathode materials described above may comprise a coating material selected from metal phosphate materials. In accordance with some embodiments of the invention, any one of the cathode materials described above may comprise a coating material comprising a mixture of a carbon material and a metal phosphate material.

In accordance with some embodiments of the invention, any one of the cathode materials described above may comprise a coating material selected from acetylene black, graphene oxide, conductive graphite, glucose, sucrose, starch, lactose, maltose, a phenolic resin, a polyvinyl alcohol, FePO₄, LiFePO₄, Co₃(PO₄)₂, Mn₃(PO₄)₂, LnPO₄, or a mixture thereof.

In accordance with some embodiments of the invention, any one of the cathode materials described above may have a coating layer thickness of 1-200 nm.

In accordance with some embodiments of the invention, any one of the cathode materials described above may have a coating material comprising 1-50% by weight of a weight of the substrate particles.

In accordance with some embodiments of the invention, any one of the cathode materials described above may have a coating layer accounting for 1-10% by weight of a weight of the cathode material.

In accordance with some embodiments of the invention, any one of the cathode materials described above may have substrate particles having particle sizes in a range of 20 nm-5 μm.

Another aspect of the invention relates to methods for producing a cathode material having a coating material coated on surfaces of a substrate material. A method in accordance with one embodiment of the invention comprises: (1) grinding and mixing a mixture of the coating material and the substrate material; (2) dispersing the mixture in a liquid medium; (3) placing the mixture of step (2) in a canister of a ball mill, and ball milling the mixture; (4) drying the mixture of step (3); (5) heating the dry mixture from step (4) in an inert atmosphere, then calcining the dry mixture, and (6) grinding the product of step (5) after cooling and mechanically fusing fine grounds to produce the cathode material.

In accordance with some embodiments of the invention, a method for coating the surfaces of a cathode material LiNi_{0.5-x}Mn_{1.5}MₓO₄ of a high-voltage lithium-ion battery comprises the following steps: (1) grinding and mixing a coating material and a cathode active material LiNi_{0.5-x}Mn_{1.5}MₓO₄ in a ratio of 1-50 wt %; (2) dispersing, by sonication, the mixture in a liquid medium, with a solid content controlled in a range of 30-40%; (3) placing the mixture of step (2) in a canister of a ball mill, and ball milling the mixture; (4) drying the mixture of step (3) at 80-120° C., for 3-5 h; (5) heating the dry mixture from step (4) in an inert atmosphere at a rate of 1-30° C./min, then calcining the dry mixture at a constant temperature in the range of 200˜700° C. for 1-5 h, and then cooling at a rate of 1˜50° C./min to room temperature or allowing the furnace to cool to room temperature, and grinding it to produce coated high-voltage lithium-ion cathode materials LiNi_{0.5-x}Mn_{1.5}MₓO₄.

In any one of the above described methods for coating the surfaces of cathode materials LiNi_{0.5-x}Mn_{1.5}MₓO₄, the active material particle sizes may be in the range of 20 nm˜5 μm;

In any one of the above described methods for coating the surfaces of cathode materials LiNi_{0.5-x} Mn_{1.5}MₓO₄, the coating material in step (1) may be acetylene black, graphene oxide, conductive graphite, glucose, sucrose, starch, lactose, maltose, phenolic resin, polyvinyl alcohol, FePO₄, LiFePO₄, Co₃(PO₄)₂, Mn₃(PO₄)₂, LnPO₄, or a mixture thereof.

In any one of the above described methods for coating the surfaces of cathode materials LiNi_{0.5-x}Mn_{1.5}MₓO₄, the coating material in step (1) may be added at 1-50% of the weight of the cathode active material.

In the above described methods for coating the surfaces of cathode materials LiNi_{0.5-x}Mn_{1.5}MₓO₄, the liquid medium in step (2) may be methanol, ethanol, acetone, tetrahydrofuran of a mixture thereof.

In any one of the above described methods for coating the surfaces of cathode materials LiNi_{0.5-x}Mn_{1.5}MₓO₄, the ultrasonic frequency in step (2) may be 40 KHz, and the ultrasonic time preferably is 10-30 min, more preferably is 25 min.

In any one of the above described methods for coating the surfaces of cathode materials LiNi_{0.5-x}Mn_{1.5}MₓO₄, the solid content in step (3) may be 30-40%, preferably the ball milling time is 2˜10 h, more preferably 5 h.

In the above described methods for coating the surfaces of cathode materials LiNi_{0.5-x}Mn_{1.5}MₓO₄, the inert gas in step (5) may be helium, neon, argon, krypton, nitrogen, or a mixture thereof.

In any one of the above described methods for coating the surfaces of cathode materials LiNi_{0.5-x}Mn_{1.5}MₓO₄, the coating thickness in step (5) is 1-200 nm.

In any one of the above described methods for coating the surfaces of cathode materials LiNi_{0.5-x}Mn_{1.5}MₓO₄, the coating layer in step (5) accounting for 1-10% of the weight of the substrate.

In combination with the drawings and examples of the present invention, the following further explains the embodiments of the invention, further illustrating of the methods and advantages of the present invention. However, the following examples are only for illustration to help one understand the present invention.

### BRIEF DESCRIPTION OF THE DRAWINGS

FIG. 1 shows a flow chart illustrating a method in accordance with one embodiment of the invention.

FIG. 2 shows XRD patterns of a sample of Example 1 in accordance with one embodiment of the invention.

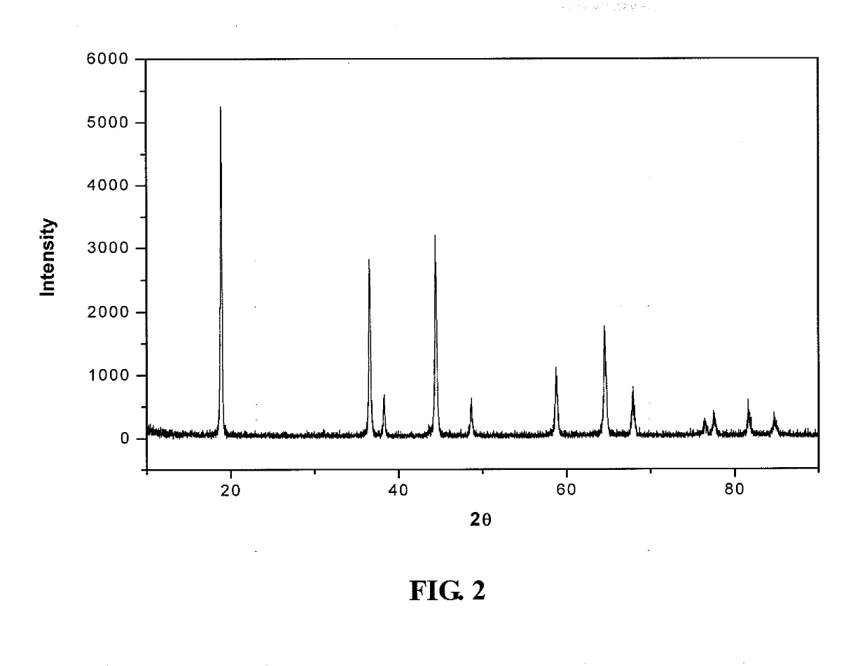

FIG. 3 shows curves illustrating different rates of charges and discharges of a sample of Example 4 in accordance with one embodiment of the invention.

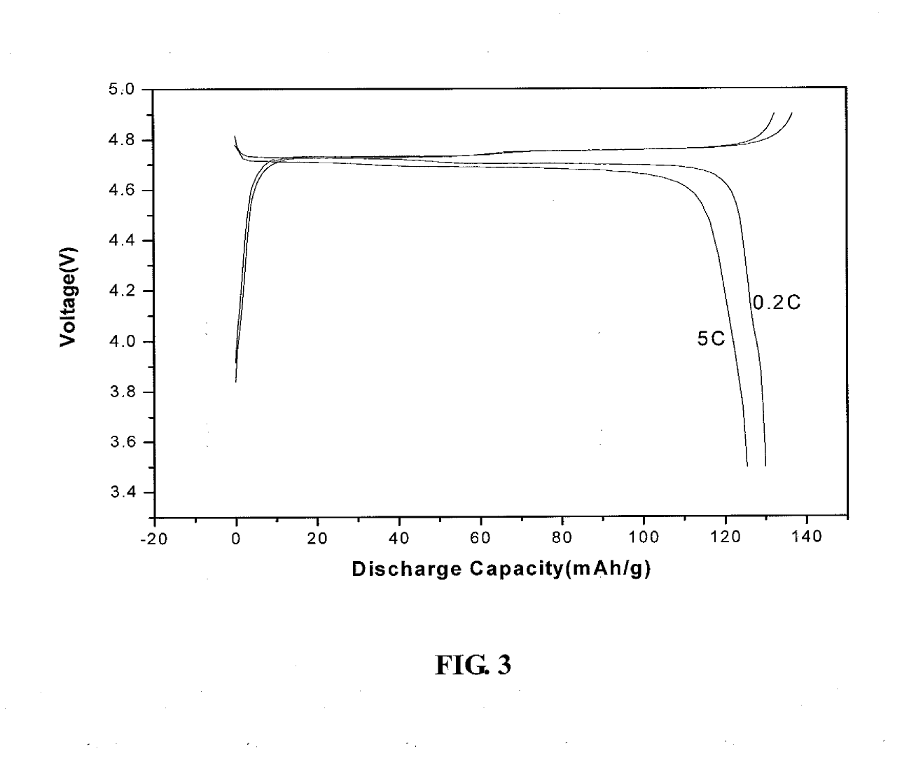

FIG. 4 shows a chart illustrating cycle performance of a sample of Example 7 in accordance with one embodiment of the invention.

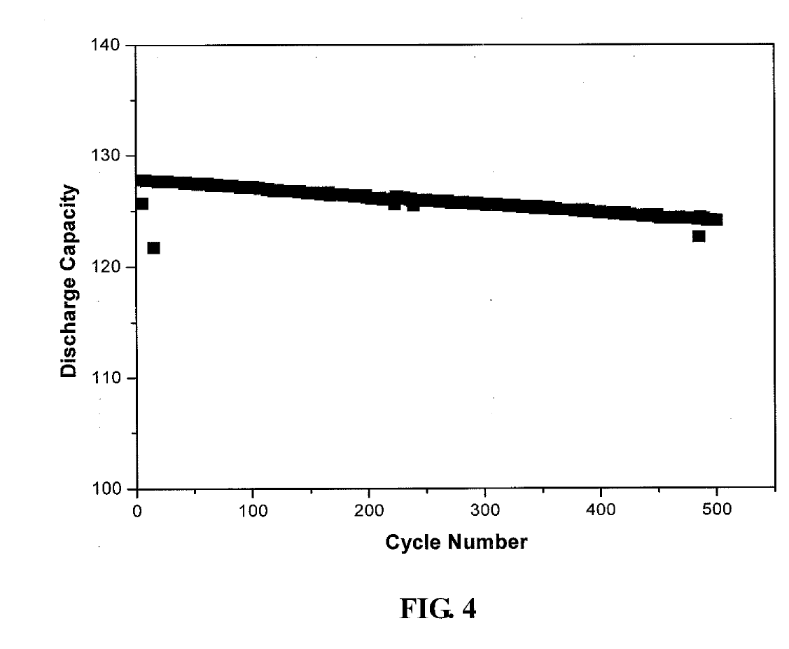

### DETAILED DESCRIPTION

Embodiments of the invention relate to methods for coating cathode materials of high-voltage lithium ion batteries. A “high-voltage” lithium ion battery as referred to here in includes any lithium ion batteries that have an operation voltage higher than 3.6 V, which is the operation voltage of current commodity lithium ion batteries. For example, a high-voltage lithium ion battery of the invention may have an operation voltage of about 5 V.

In accordance with some embodiments of the invention, a cathode active material may be coated with a functional material. A cathode active material of the invention may be based on a material similar to natural spinel LiMn₂O₄. However, a cathode active material of the invention may include a small amount of nickel cation in addition to lithium cation. In addition, a cathode active material of the invention may include a small amount of an anion other than mangante. For example, a cathode active material may have a formula of LiNi_{0.5-x}Mn_{1.5}MₓO₄, wherein 0≦x≦0.2, and M═Mg, Zn, Co, Cu, Fe, Ti, Zr, Ru, or Cr.

A functional material may comprise a carbon material and/or a metal phosphate. A carbon material may be any carbon-containing compounds that will deposit a carbon-coating on the surfaces of the substrates. Such materials would include most organic compounds that can be decomposed to produce carbon at high temperature. Examples of carbon materials for use with embodiments of the invention may include, but are not limited to: acetylene black, graphite, graphene, graphene oxide, carbohydrates (e.g., glucose, sucrose, lactose, maltose, starch, etc.), phenolic resin, polyvinyl alcohol, and the like.

In accordance with some embodiments of the invention, a coating material may be a metal phosphate. Examples of metal phosphates may include, but are not limited to: Li₃PO₄, Na₃PO₄, K₃PO₄, Ca₃(PO₄)₂, FePO₄, LiFePO₄, Co₃(PO₄)₂, Mn₃(PO₄)₂, LnPO₄, or the like.

In accordance with embodiments of the present invention, a coating on a cathode active material for high-voltage lithium-ion batteries may be any suitable amount, e.g., 1-30%, preferably 1-20%, more preferably 1-10%, wherein the % is based on the mass of the substrates (LiNi_{0.5-x}Mn_{1.5}MₓO₄ substrate), of a functional material selected from a carbon material, a metal phosphate material, of a combination thereof. Please note that any numerical range disclosed in this description is intended to include all numbers within the range, as if these individual numbers had been separately disclosed.

The high-voltage lithium ion battery cathode materials produced with methods of the invention have a coating of a carbon material and/or a metal phosphate. A carbon coating on a cathode material has been found to improve conductance. Similarly, metal phosphate materials have been shown to confer desirable properties to a cathode material. Therefore, in accordance with embodiments of the invention, cathode active materials having carbon and/or metal phosphate coatings have high discharge rates and high cycle stabilities.

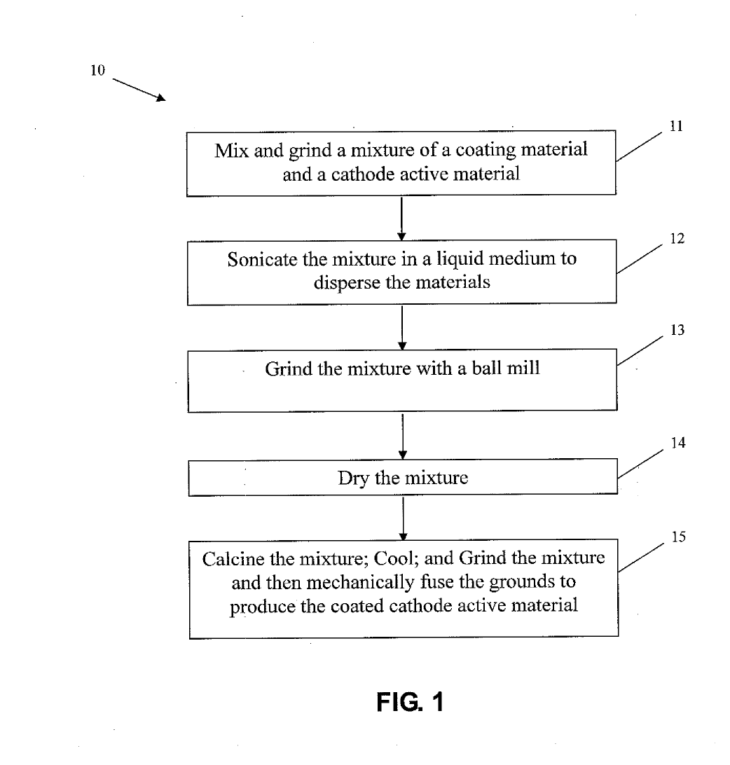

FIG. 1 illustrates a method in accordance with one embodiment of the invention. As shown, a method 10 may start with mixing and grinding a mixture that comprises a coating material (i.e., a functional material) and a cathode active material (i.e., a substrate) (step 11). The mixture then may be dispersed in a liquid medium. The dispersion for example may be accomplished with sonication or another suitable means. (Step 12).

The dispersed mixture may be further mixed and ground to produce a relatively homogeneous mixture of fine powders. (Step 13). The mixture is then dried under a suitable condition (e.g., at an elevated temperature). The drying process is performed in a dynamic state to prevent different materials from depositing with different rates. (Step 14).

Finally, the dried mixture is calcined at a high temperature. After the products from calcination are cooled to room temperature, they are ground and then mechanically fusing the fine grounds to produce the coated cathode active material powders (or particles). (Step 15). This is to mix the coating material and the active material at a nano scale, making the coating material particles adherent to the surface of the cathode material. In this description, such product powders (coated cathode active material powders) may also be referred to as “particles.” That is, the terms “powders” and “particles” may be used interchangeably.

Embodiments of the invention will be further illustrated with the following specific examples. One skilled in the art would appreciate that these examples are for illustration only and are not intended to limit the scope of the invention.

### EXAMPLE 1

Grind and mix a mixture of an active substance LiNi_{0.48}Mn_{1.5}Fe_{0.02}O₄ (5 g) and acetylene black (0.5 g). Disperse the mixture in 25 ml of anhydrous ethanol, and pulverize the mixture with sonication for 20 min. Ball mill the above mixture in ethanol for 3 h. Dry it at 80° C. for 3 h. Grind the mixture to powders. Calcine the powders in a nitrogen atmosphere at 300° C. for 1 h, and then allow the furnace to cool down to room temperature. Grind the calcined products to produce carbon-coated high-voltage cathode materials.

Use 1.2M LiPF₆ EC:EMC:DMC (1:1:1, V/V) as an electrolyte and lithium metal as an anode to assemble a 2016 button battery. Using a Land charge and discharge tester, after cycling at 2 C for 500 times, this material was found to retain the capacity at 95%.

### EXAMPLE 2

Grind and mix a mixture of an active substance LiNi_{0.45}Mn_{1.5}Ti_{0.05}O₄ (5 g) and sucrose (2 g). Disperse the mixture in 25 ml of anhydrous ethanol, and pulverize the mixture with sonication for 20 min. Ball mill the above mixture in ethanol for 2 h. Dry it at 80° C. for 3 h. Grind the mixture to powders. Calcine the powders in a nitrogen atmosphere at 300° C. for 3 h, and then allow the furnace to cool down to room temperature. Grind the calcined products to produce carbon-coated high-voltage cathode materials.

Use 1.2M-LiPF₆ EC:EMC:DMC (1:1:1, V/V) as an electrolyte and lithium metal as an anode to assemble a 2016button battery. Using a Land charge and discharge tester, this material was found to have a discharge capacity of 127 mAh/g at 5 C discharge rate, which is 98% of the capacity at 0.2 C discharge rate.

### EXAMPLE 3

Grind and mix a mixture of an active substance LiNi_{0.45}Mn_{1.5}Mg_{0.05}O₄ (5 g) and acetylene black (0.5 g). Disperse the mixture in 25 ml of anhydrous ethanol, and pulverize the mixture with sonication for 20 min. Ball mill the above mixture in ethanol for 3 h. Dry it at 80° C. for 3 h. Grind the mixture to powders. Calcine the powders in a nitrogen atmosphere at 300° C. for 1 h, and then allow the furnace to cool down to room temperature. Grind the calcined products to produce carbon-coated high-voltage cathode materials.

Use 1.2M-LiPF₆ EC:EMC:DMC (1:1:1, V/V) as an electrolyte and lithium metal as an anode to assemble a 2016 button battery. Using a Land charge and discharge tester, this material was found to have a discharge capacity of 128 mAh/g at 5 C discharge rate and to retain the capacity at 96% after cycling at 2 C for 500 times.

### EXAMPLE 4

Grind and mix a mixture of an active substance LiNi_{0.48}Mn_{1.5}Fe_{0.02}O₄ (5 g), graphene oxide (0.5 g), and glucose (2 g). Disperse the mixture in 35 ml of anhydrous acetone, and pulverize the mixture with sonication for 20 min. Ball mill the above mixture in acetone for 2 h. Dry it at 80° C. for 1 h. Grind the mixture to powders. Calcine the powders in a nitrogen atmosphere at 300° C. for 2 h, and then allow the furnace to cool down to room temperature. Grind the calcined products to produce carbon-coated high-voltage cathode materials.

Use 1.2M-LiPF₆ EC:DMC (1:1, V/V) as an electrolyte and lithium metal as an anode to assemble a 2016 button battery. Using a Land charge and discharge tester, this material was found to have a specific discharge capacity of 129 mAh/g at 0.2 C discharge rate and a discharge capacity of 126 mAh/g at 5 C discharge rate.

### EXAMPLE 5

Grind and mix a mixture of an active substance LiNi_{0.45}Mn_{1.5}Cr_{0.05}O₄ (5 g) and FePO₄ (0.5 g). Disperse the mixture in 25 ml of anhydrous ethanol, and pulverize the mixture with sonication for 30 min. Ball mill the above mixture in ethanol for 2 h. Dry it at 80° C. for 3 h. Grind the mixture to powders. Calcine the powders in a nitrogen atmosphere at 200° C. for 1 h, and then allow the furnace to cool down to room temperature. Grind the calcined products to produce FePO₄-coated high-voltage cathode materials.

Use 1.2M LiPF₆ EC:DMC (1:1, V/V) as an electrolyte and lithium metal as an anode to assemble a 2016 button battery. Using a Land charge and discharge tester, this material was found to have a discharge capacity of 127 mAh/g at 5 C discharge rate and to retain 96% capacity after 500 charge-discharge cycles at a rate of 2 C.

### EMBODIMENT 6

Grind and mix a mixture of an active substance LiNi_{0.35}Mn_{1.5}Co_{0.15}O₄ (5 g), and FePO₄ (0.25 g), and LnPO₄ (0.25 g). Disperse the mixture in 25 ml of anhydrous ethanol, and pulverize the mixture with sonication for 30 min. Ball mill the above mixture in ethanol for 2 h. Dry it at 80° C. for 3 h. Grind the mixture to powders. Calcining the powders in a nitrogen atmosphere at 200° C. for 1 h, and then allow the furnace to cool down to room temperature. Grind the calcined products to produce FePO₄ and LnPO₄-coated high-voltage cathode materials.

Use 1.2M LiPF₆ EC:DMC (1:1, V/V) as an electrolyte and lithium metal as an anode to assemble a 2016 button battery. Using a Land charge and discharge tester, this material was found to have a discharge capacity of 125 mAh/g at 5 C discharge rate and to retain 95% capacity after 500 charge-discharge cycles at a rate of 2 C.

### EMBODIMENT 7

Grind and mix a mixture of an active substance LiNi_{0.48}Mn_{1.5}Ru_{0.02}O₄ (5 g), LiFePO₄ (0.5 g), and sucrose (4 g). Disperse the mixture in 25 ml of anhydrous ethanol, and pulverize the mixture with sonication for 30 min. Ball mill the above mixture in ethanol for 2 h. Dry it at 80° C. for 3 h. Grind the mixture to powders. Calcining the powders in a nitrogen atmosphere at 300° C. for 3 h, and then allow the furnace to cool down to room temperature. Grind the calcined products to produce carbon and LiFePO₄-coated high-voltage cathode materials.

Use 1.2M LiPF₆ EC:DMC (1:1, V/V) as an electrolyte and lithium metal as an anode to assemble a 2016 button battery. Using a Land charge and discharge tester, this material was found to have a discharge capacity of 128 mAh/g at 5 C discharge rate and to retain 98% capacity after 300 charge-discharge cycles at a rate of 2 C.

The present invention has the one or more of the following advantages: (1) The present invention uses ultrasonic and mechanical two-step mixing, which facilitates homogeneous mixing; (2) improved surface chemistry of the active materials, suppressing side reactions and improving the conductivity of the active materials, thereby greatly improving the rate and cycling performance of the cathode active materials.

While this invention has been described in terms of certain embodiments thereof, it is not intended that it be limited to the above description, but rather only to the extent set forth in the following claims. The embodiments of the invention in which an exclusive property or privilege is claimed are defined in the following claims.

What is claimed is:

1. A cathode material, comprising:
substrate particles comprising a substance having the formula: LiNi_{0.5-x}Mn_{1.5}MₓO₄, wherein 0≦x≦0.2, and M is Mg, Zn, Co, Cu, Fe, Ti, Zr, Ru, or Cr; and
a coating material coated on surfaces of the substrate particles, wherein the coating material comprises a carbon material, a metal phosphate material, or a combination thereof.

2. The cathode material according to claim 1, wherein the coating material is the carbon material.

3. The cathode material according to claim 1, wherein the coating material is the metal phosphate material.

4. The cathode material according to claim 1, wherein the coating material is a mixture of the carbon material and the metal phosphate material.

5. The cathode material according to claim 1, wherein the coating material is acetylene black, graphene oxide, conductive graphite, glucose, sucrose, starch, lactose, maltose, a phenolic resin, a polyvinyl alcohol, FePO₄, LiFePO₄, Co₃(PO₄)₂, Mn₃(PO₄)₂, LnPO₄, or a mixture thereof.

6. The cathode material according to claim 1, wherein a coating layer thickness is 1-200 nm.

7. The cathode material according to claim 1, wherein the coating material comprises 1-50% by weight of a weight of the substrate particles.

8. The cathode material according to claim 1, wherein the coating layer accounts for 1-10% by weight of a weight of the cathode material.

9. The cathode material according to claim 1, wherein the substrate particles have particle sizes in a range of 20 nm-5 μm.

10. The cathode material according to claim 1, wherein the coating material is coated on the surfaces of the substrate particles by the following steps:
(1) grinding and mixing a mixture of the coating material and the substrate particles;
(2) dispersing, by sonication, the mixture in a liquid medium, with a solid content controlled in a range of 30-40%;
(3) placing the mixture of step (2) in a canister of a ball mill, and ball milling the mixture;
(4) drying the mixture of step (3) at 80-120° C., for 3-5 h;
(5) heating the dry mixture from step (4) in an inert atmosphere at a rate of 1-30° C./min, then calcining the dry mixture at a temperature in a range of 200˜700° C. for 1-5 h, and then cooling at a rate of 1˜50° C./min to room temperature or allowing the furnace to cool to room temperature, and
(6) grinding the product from step (5) and mechanically fusing fine grounds to produce the cathode material.

11. A method for producing a cathode material having a coating material coated on surfaces of a substrate material, the method comprising:
(1) grinding and mixing a mixture of the coating material and the substrate material;
(2) dispersing the mixture in a liquid medium;
(3) placing the mixture of step (2) in a canister of a ball mill, and ball milling the mixture;
(4) drying the mixture of step (3);
(5) heating the dry mixture from step (4) in an inert atmosphere, then calcining the dry mixture, and
(6) grinding the product of step (5) after cooling and mechanically fusing fine grounds to produce the cathode material.

12. The method according to claim 11, wherein the dispersing is by sonication with a frequency of 40 KHz and a duration of 10-30 min.

13. The method according to claim 11, wherein the liquid medium is methanol, ethanol, acetone, tetrahydrofuran, or a mixture thereof.

14. The method according to claim 11, wherein the inert gas is helium, neon, argon, krypton, nitrogen, or a mixture thereof.

15. The method according to claim 11, wherein in step (2), the solid content in the liquid medium is 30-40%.

16. The method according to claim 11, wherein in step (3), the drying is performed at 80-120° C., for 3-5 h.

17. The method according to claim 11, wherein in step (4), the solid content is 30-40%, and a milling duration is 2-10 h.

18. The method according to claim 11, wherein the heating in step (5) is performed at a rate of 1-30° C./min, and the calcining is performed at a constant temperature in the range of 200˜700° C. for 1-5 h.

19. The method according to claim 11, wherein the coating material in step (1) comprises 1-50% by weight based on a weight of the substrate particles.

20. The method according to claim 11, wherein in step (5), a coating layer thickness is 1-200 nm.
